(19) United States
(12) Patent Application Publication
(10) Pub. No.: US 2004/0240206 A1
(43) Pub. Date: Dec. 2, 2004

(54) Laser pointer with external power

(76) Inventor: Tzu-Yun Yeh, Shinfeng Shiang (TW)

Correspondence Address: Keith Kline, PRO-TECHTOR INTERNATIONAL SERVICES, 20775 Norada Cout, Saratoga, CA, 95070-3018, US

(21) Appl. No.: 10/675,425

(22) Filed: Sep. 29, 2003

(30) Foreign Application Priority Data
Jun. 2, 2003 (TW) 92210128

(51) Int. Cl. F21K 2/00

(52) U.S. Cl. 362/259

(57) ABSTRACT

A laser pointer with external power is disclosed, which comprises a laser generator, an interface for external-power connection, and a current limiting resistor. The laser generator is to generate laser beams. The interface for external-power connection is coupled to a power supply device for providing power to the laser generator. Besides, the power switch is to control whether the power should be conducted to the laser generator. Also, the current limiting resistor is connected between the laser generator and the interface for external-power connection to protect the laser generator from damage caused by the current-overload of the laser generator.

### BACKGROUND OF THE INVENTION

1. Field of the Invention

The invention relates to a laser pointer and, more particularly, to a laser pointer with external power.

2. Description of the Related Art

Laser technique has been applied to technical fields related to medical care, industry, and military for years. A laser pointer, however, is often used in teaching, lectures, or conferences for pointing out the subjects. As shown in FIG. 1, the basic components of a laser pointer include a laser diode 11 that is connected to a power source 12, a power switch 13 that is connected between the laser diode 11 and the power source 12, and a current limiting resistor 14. The laser diode 11 is to generate laser beams; the current limiting resistor 14 is to protect the laser diode 11 from damage caused by the current-overload of the laser diode 11; and the power switch 13 is to conduct the power source 12 according to the user's demand so that the laser diode 11 can generate laser beams and project them to the spot demanded by the user.

A laser pointer is preferred to have a lightweight for better portability and operation. Therefore, the power supply of a conventional laser pointer always relies on a battery, which unfortunately generates the following drawbacks. First, because laser diode 11 consumes a lot of power, the lifespan of the battery tends to be short. For this reason, power shortage is more likely to occur when the laser pointer is in use, which in turn will result in more battery replacements, and doing more battery replacements certainly means more inconvenience to the user. Besides, a large consumption of batteries means the cost of using a laser pointer will be increased, and a waste battery also increases the environmental pollution.

Therefore, it is imperative that the above-mentioned problems can be resolved in order that the laser pointer may have sufficient and stable power supply. Also, the consumption of batteries as well as the cost of using the laser pointer can be reduced. Meanwhile, the environmental pollution caused by the waste battery can be alleviated as well.

### SUMMARY OF THE INVENTION

In viewing of the aforementioned problems, the object of the invention is to provide a laser pointer with external power, which can be connected to a sufficient and stable external power supply to reduce the occurrence of power loss when the laser pointer is in use.

Another object of the invention is to provide a laser pointer with external power, which can reduce the dependence on battery, the cost of using the laser pointer, and the environmental pollution caused by a waste battery.

To achieve the above-mentioned objects, the laser pointer with external power of the invention includes a laser generator, an interface for external-power connection, a power switch, and a current limiting resistor. The laser generator is to generate laser beams. The interface for external-power connection is coupled to a power supply device, and the power supply device is to provide power to the laser generator. The power switch is connected between the laser generator and the interface for external-power connection, and when in use, the power switch will conduct power from the power supply device to the laser generator. In addition, the current limiting resistor is also connected between the laser generator and the interface for external-power connection to protect the laser generator from damage caused by the current-overload of the laser generator.

The laser pointer with external power of the invention can be externally connected to and use the power provided by the power supply device; therefore, the occurrence of power loss when the laser pointer is in use will be reduced. Meanwhile, the battery consumption can be reduced, and in turn the cost of battery replacement can be reduced as well. As a result, the environmental pollution caused by the waste battery can be alleviated.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram showing the circuits of a conventional laser pointer;

FIG. 2 is a schematic diagram showing the circuits of the laser pointer with external power according to the first embodiment of the invention;

FIG. 3 is a schematic diagram showing the circuits of the laser pointer with external power according to the second embodiment of the invention;

FIG. 4 is a schematic diagram showing the circuits of the laser pointer with external power according to the third embodiment of the invention.

### DETAILED DESCRIPTION OF THE PREFERRED EMBODIMENTS

The laser pointer with external power according to the embodiments of the invention will be described below with reference to the drawings, wherein the same components will be illustrated by the same reference numerals.

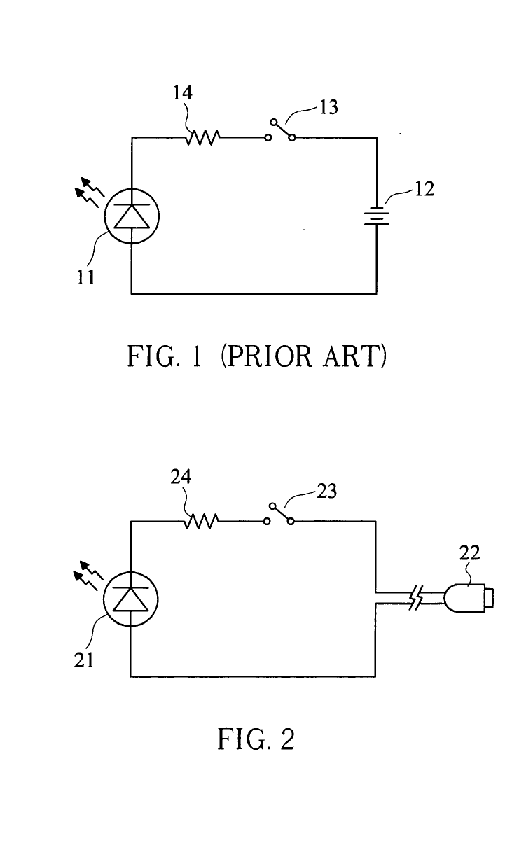

Referring to FIG. 2, the laser pointer with external power according to the first embodiment of the invention includes a laser generator 21, an interface for external-power connection 22, a power switch 23, and a current limiting resistor 24. The laser generator 21 is to generate laser beams, which, for instance, can be used to point out the theme of a lecture or a brief. In the embodiment, the laser generator 21 is a laser diode. The interface for external-power connection 22 is to be connected to and use power of a power supply device. The power switch 23 is connected between the laser generator 21 and the interface for external-power connection 22, and when in use, the user can conduct the power from the power supply device to the laser generator 21. Besides, the current limiting resistor 24 is also connected between the laser generator 21 and the interface for external-power connection 22 to protect the laser generator 21 from damage caused by the current-overload of the laser generator 21.

Next, an example will be illustrated to explain how the laser pointer with external power is in operation. The laser pointer of the invention employs the sufficient power provided by a conventional computer system since the computer system equipped with software has been widely applied in a lecture or a presentation so that a brief, for example, can be projected through a projection device. Currently, an interface, such as a USB (Universal Serial Bus) interface, an IEEE 1394 interface, and a PS/2 interface that can be connected to a peripheral device, is capable of providing power for the peripheral device. Specifically, the interface for external-power connection 22 of the invention is compatible to the above-mentioned interfaces and can be connected to the computer system so that the laser pointer with external power of the invention can use the power supplied by the computer system. When the power from the computer system is sufficient and stable, the laser pointer with external power of the invention can be free from encountering a power loss when used during a lecture or a presentation.

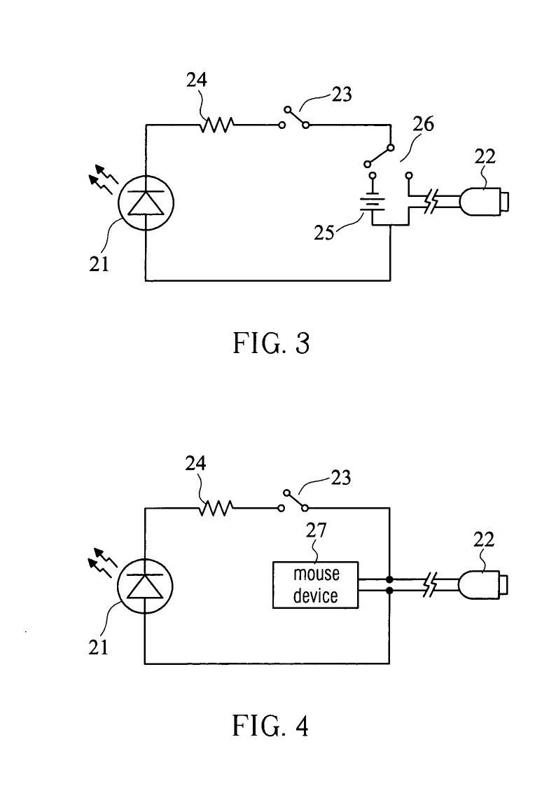

Also, the laser pointer with external power according to the second embodiment of the invention is shown in FIG. 3, which further includes a battery module 25 and a switch 26 in addition to the components included in FIG. 2. The battery module 25 is to supply power for the laser generator 21, while the switch 26 is to alternatively conduct the power from the battery module 25 or from the power supply device to the laser generator 21. Therefore, when the laser pointer with external power of the invention does not have a power supply device available for power connection, the user can press the switch 26 and switch to the battery module 25 for supplying the power needed by the laser generator 21. Hence, the laser pointer with external power of the invention can be used independently.

Furthermore, the laser pointer with external power according to the third embodiment of the invention is shown in FIG. 4, which further includes a mouse device 27 in addition to the components included in FIG. 2. The mouse device 27 shares the interface for external-power connection 22 with the laser generator 21 and is connected to the computer device, which enables the laser pointer with external power to have the functions of the mouse device 27. However, since the functions of the mouse device 27 are well-known conventional techniques, they will not be reiterated here.

The laser pointer with external power can be externally connected to and use the power provided by the power supply device so as to reduce the possibility of power loss when in use. In addition, compared to a conventional laser pointer that uses a battery as its power source, the laser pointer with external power can reduce the consumption of batteries; therefore, the cost of buying batteries can be reduced. As a result, the environmental pollution caused by the waste batteries can be alleviated.

The embodiments above are only intended to illustrate the invention; they do not, however, to limit the invention to the specific embodiments. Anyone who is skilled in the art may conduct changes of equivalent effects in according to the above-mentioned embodiments of this invention without departing from the spirit and scope of the invention, such as, a projection device, which is equipped with an interface that is compatible to the interface for external-power connection, can be used as an power supply device to provide power for the laser generator. Accordingly, various modifications and changes may be made without departing from the spirit and scope of the invention as described in the appended claims.

What is claimed is:

1. A laser pointer with external power, comprising:
a laser generator, for generating laser beams;
an interface for external-power connection, which is connected to a power supply device and provides power to said laser generator;
a current limiting resistor, which is connected between said laser generator and said interface for external-power connection to protect said laser generator from damage caused by the current-overload of said laser generator; and
a power switch, which is connected between said laser generator and said interface for external-power connection to conduct power to said laser generator when said laser pointer with external power is in use.

2. The laser pointer with external power as claimed in claim 1, wherein said laser generator is a laser diode.

3. The laser pointer with external power as claimed in claim 1, wherein said interface for external-power connection is an interface of Universal Serial Bus (USB).

4. The laser pointer with external power as claimed in claim 1, wherein said interface for external-power connection is an interface of IEEE 1394.

5. The laser pointer with external power as claimed in claim 1, wherein said interface for external-power connection is an interface of PS/2.

6. The laser pointer with external power as claimed in claim 1, wherein said power supply device is a computer system.

7. The laser pointer with external power as claimed in claim 6, further including:
a mouse device, which shares said interface for external-power connection with said laser generator.

8. The laser pointer with external power as claimed in claim 1, further comprising:
a battery module, to supply power to said laser generator; and
a switch, to alternatively conduct power from said battery module or from said power supply device to said laser generator.

9. The laser pointer with external power as claimed in claim 8, wherein said interface for external-power connection is an interface of Universal Serial Bus (USB).

10. The laser pointer with external power as claimed in claim 8, wherein said interface for external-power connection is an interface of IEEE 1394.

11. The laser pointer with external power as claimed in claim 8, wherein said interface for external-power connection is an interface of PS/2.
